(19) United States
(12) Patent Application Publication
(10) Pub. No.: US 2025/0348783 A1
(43) Pub. Date: Nov. 13, 2025

(54) DATA STORE FOR FEATURE ENGINEERING

(71) Applicant: Wells Fargo Bank, N.A., San Francisco, CA (US)

(72) Inventors: Arnab Dan, Naperville, IL (US); Suhas Niranjan Yelluru, Freemont, CA (US); Krishnakumar Chellappa, Indian Land, SC (US)

(21) Appl. No.: 18/662,692

(22) Filed: May 13, 2024

(51) Int. Cl. G06N 20/00

(52) U.S. Cl. CPC G06N 20/00

(57) ABSTRACT

This disclosure describes techniques for managing both batch and streaming data and managing the efficient and timely calculation of features that are based on such data. In one example, this disclosure describes a method that includes receiving, by a computing system, batch and streaming data; generating, by the computing system and based on the batch and streaming data, a preliminary set of calculated features; receiving, by the computing system, a request to score input data; identifying, by the computing system and based on information included in the request, a model and input features for the model; generating, by the computing system and using the preliminary set of calculated features, the input features; applying the model, by the computing system, to the input features to generate model output data; and outputting, by the computing system, the model output data.

### TECHNICAL FIELD

This disclosure relates to generating features for use in artificial intelligence models, and more specifically, to techniques for efficiently managing and performing feature engineering processes.

### BACKGROUND

Feature engineering in the context of artificial intelligence (AI) refers to the process of transforming raw data into relevant information that can be effectively used by machine learning models. Features are input variables used by a machine learning model to make predictions. Features can be derived from raw data or constructed based on domain knowledge.

Often, model performance depends on the quality of data used during training. Feature engineering optimizes machine learning model performance by transforming raw data into meaningful features and selecting relevant features for a specific predictive task and model type.

### SUMMARY

This disclosure describes techniques for managing ingestion of both batch and streaming data as well as techniques for managing the efficient and timely calculation of features that are based on such data. In particular, techniques described herein may enable extremely fast performance of feature engineering tasks, including on-the-fly generation and/or calculation of features to be used in time-critical machine learning models. Techniques described herein enable use of complex features in even high-demand contexts, where such features are needed in near- or seemingly near-real time.

Also described herein are information collection and management techniques that enable monitoring, access control, and compliance capabilities pertaining to feature engineering. Such techniques may also be used to maintain information about features and calculations performed to generate the features. Information about features and underlying calculations may be maintained in a registry of information that enables efficient ongoing calculation of features across both real time and historical time frames.

In some examples, this disclosure describes operations performed by a computing system in accordance with one or more aspects of this disclosure. In one specific example, this disclosure describes a method comprising receiving, by a computing system, batch and streaming data; generating, by the computing system and based on the batch and streaming data, a preliminary set of calculated features; receiving, by the computing system, a request to score input data; identifying, by the computing system and based on information included in the request, a model and input features for the model; generating, by the computing system and using the preliminary set of calculated features, the input features; applying the model, by the computing system, to the input features to generate model output data; and outputting, by the computing system, the model output data.

In another example, this disclosure describes a system comprising a storage system and processing circuitry having access to the storage system, wherein the processing circuitry is configured to carry out operations described herein. In yet another example, this disclosure describes a computer-readable storage medium comprising instructions that, when executed, configure processing circuitry of a computing system to carry out operations described herein.

The details of one or more examples of the disclosure are set forth in the accompanying drawings and the description herein. Other features, objects, and advantages of the disclosure will be apparent from the description and drawings, and from the claims.

### BRIEF DESCRIPTION OF THE DRAWINGS

FIG. 1 is a conceptual diagram illustrating an example system for processing features in a time-sensitive artificial intelligence environment, in accordance with one or more aspects of the present disclosure.

FIG. 2 is an alternative conceptual diagram illustrating an example system for processing features and performing feature engineering tasks in a time-sensitive artificial intelligence environment, in accordance with one or more aspects of the present disclosure.

FIG. 3 is a block diagram illustrating an example system for processing features and performing administrative tasks in a time-sensitive artificial intelligence environment, in accordance with one or more aspects of the present disclosure.

FIG. 4 is a flow diagram illustrating operations performed by an example computing system, in accordance with one or more aspects of the present disclosure.

### DETAILED DESCRIPTION

Real time feature engineering for AI models requires an extremely fast event processing mechanism capable of running complex algorithms in near- or seemingly near-real time to compute features from raw data. In some industries, like finance, the expected application response time is often on the order of milliseconds or faster. As a result, a system for performing feature engineering in such contexts should be capable of (1) low-latency access and processing, (2) scalability (i.e., supporting lots of requests and processing), (3) versioning, (4) access control, (5) providing services through an accessible application programming interface (“API”) for creating and accessing features, and (6) exposing an easy-to-use interface. A feature engineering system with these capabilities is well suited to achieve business requirements that include time sensitivity, favorable customer-facing impact, and adherence to service level agreements.

This disclosure describes using a low latency data store as a “feature store” for machine learning operations, where near- or seemingly near-real time feature computations are performed using the feature store. A machine learning operations data connector, which may be implemented as an API or API layer that provides feature engineering services, can be used to abstract or hide complex operations performed by the underlying feature store. In other words, such an API can simplify, from a user's perspective, complex operations that are performed by underlying feature store logic.

Such complex operations may include ingesting both batch (e.g., historical) data and real time streaming data and storing both the batch and streaming data in the same low latency data store. Such operations may also include processing the ingested data, generating features based on both the batch and streaming data, receiving requests to perform a prediction based on input or payload data, and replying to such requests by applying the appropriate model to the input data and appropriate features calculated from the batch and streaming data. As described herein, by processing raw data in the form of batch and streaming data, and managing performance of feature calculations efficiently across multiple timeframes, the disclosed feature store can calculate features in a sufficiently timely manner to satisfy the requirements of highly time-sensitive applications.

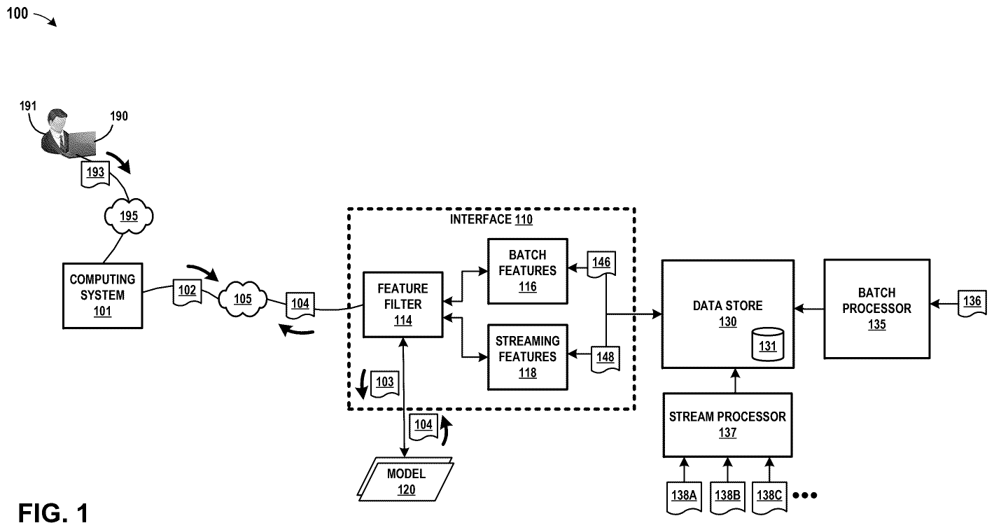

FIG. 1 is a conceptual diagram illustrating an example system for processing features in a time-sensitive artificial intelligence environment, in accordance with one or more aspects of the present disclosure. System 100 of FIG. 1 includes computing system 101 and interface 110 communicating over network 105. Interface 110 includes a number of elements, including feature filter 114, batch feature filter 116, and streaming feature filter 118. Computing system 101 may cause one or more of models 120 to make a prediction or generate a score by sending a request (e.g., request 102) over network 105 to interface 110. Interface 110 may use the request to assemble model input data 103, which, as described herein, may involve feature filter 114 interacting with batch feature filter 116 and streaming feature filter 118 to collect appropriate features from data store 130. Interface 110 may apply one or more models 120 to the model input data 103 by sending model input data 103 to the desired models 120. In response, interface 110 receives model output data 104. Interface 110 responds to request 102 by outputting model output data 104 over network 105 to computing system 101.

The described process may be performed in many different contexts. For instance, computing system 101 may be a web site or other system that collects information and/or provides a service, such as accepting a loan application or an application to open an account at a financial institution. Interface 110 may provide access to one or more models 120 that assist computing system 101 in determining whether to approve the loan application or open the account. In such an example, user 191 may be an existing or prospective customer of a bank seeking to take out a loan or open an account. Device 190, which may be operated by user 191, communicates with computing system 101 (e.g., a bank web site) over network 195 (e.g., network 195 may be the internet). Computing system 101 may interact with interface 110, causing interface 110 to apply one or more of models 120 to information about user 191 and thereby determine whether to approve a loan or open an account requested by user 191. If approved, computing system 101 may interact with other systems as part of a process for creating a loan account or other account. If denied, computing system 101 may output a user interface to device 190 (e.g., informing user 191 of the decision and/or suggesting alternatives).

In another example, computing system 101 may be a web site that processes transactions, such as credit card transactions performed by user 191. In this case, user 191 may be a merchant processing a customer's credit card at a physical point-of-sale location at a retail store. Computing system 101 may be a transaction processing system that relies one or more models 120 that are trained to determine whether to approve or deny credit card transactions. In such an example, computing system 101 receives information about a new transaction from device 190 over network 195 and interacts with interface 110 to assess whether the transaction is legitimate or fraudulent. Interface 110 causes an appropriate model 120 to make a prediction, and outputs information (e.g., model output data 104) about the prediction to computing system 101. Computing system 101 uses the information about the prediction to determine whether to approve the transaction. If, based on the prediction, the credit card transaction is approved, computing system 101 may provide an indication of transaction approval to device 190. Computing system 101 may also interact with other systems to complete the transaction and perform other administrative tasks (e.g., log the transaction to the customer's account). If the credit card transaction is denied, computing system 101 may communicate that denial decision to device 190 and, possibly, send information to other systems about the decision to deny the transaction.

In yet another example, computing system 101 may be an externally facing system that is part of an enterprise network, providing information and services to authorized users. In such an example, computing system 101 may receive credentials from device 190 and computing system 101 may gate access to protected resources on the enterprise network based on the credentials and/or other information. Interface 110 may provide access to one or more models 120 that determine whether user 191 operating device 190 should be authenticated. In this context, computing system 101 may interact with interface 110 and use the credentials received from device 190 to determine whether device 190 (or user 191 operating device 190) should be authorized to use computing system 101. If authorized, computing system 101 may enable access and perform functions in response to requests received from device 190. If not authorized, computing system 101 may deny access and/or take other actions, particularly where the failed access may represent a possible threat to protected resources (e.g., network resources on an enterprise network). In other words, computing system 101 may take actions to mitigate the threat by communicating with other systems.

There are many other examples in which interface 110 provides access to one or more of models 120. The feature engineering techniques described herein may be widely applicable across many examples and contexts.

When interface 110 applies a model 120 to determine how to respond to requests in various situations, such as those described above, the model 120 may require data relevant to the request. That data may be drawn from multiple time frames, including very recent or even real time data, and may extend to historical data that may be based on events that happened months ago or longer. For example, determining whether to approve a loan application for user 191 may require information about the credit history associated with user 191, and relevant information about a user's credit history may involve both very recent events as well as events that took place months or years before the loan application was received. Similarly, determining whether to approve a credit card transaction may require information about very recent use of the credit card as well as credit card transactions (and payment history) that may involve timeframes spanning months or years. Also, determining whether a given attempt to access computing system 101 may be a network hacking attempt may require information about ongoing or real time events occurring on the network as well as historical information about prior hacking strategies that have been used in past against the network or other networks.

Accordingly, models 120 may need access to data across multiple timeframes in order to make accurate predictions. As a result, calculating features for use by a model, or other feature engineering tasks, necessarily involves use of data drawn from timeframes that extend from real time streaming data to historical data about events that occurred long ago.

FIG. 1 illustrates data store 130, which may be used for storage of data for multiple time frames. As described herein, data store 130 may store data used by one or more of models 120 and/or for generating features that are used by models 120. Such data may be ingested by data store 130 in the form of multiple streams of data, such as raw streaming data 138A, 138B, and 138C (collectively, “raw streaming data 138,” and representing any number of such streams of data).

Such streams of data may be near-real time data (or seemingly near-real time data), representing the most up-to-date or most recent data associated with a given topic or event occurrence. For example, an instance of raw streaming data 138 may report information about changes to a given user's credit score or events that may affect the user's credit score, where such information is reported by the stream of data as such events occur. In another example, an instance of raw streaming data 138 may report a sequence of credit card transactions that are collected and presented as raw streaming data 138 minutes or seconds after the actual credit card transactions occur. In yet another example, raw streaming data 138 may be a stream of data about various network events, such as access attempts on an enterprise network, which may include both failed and successful attempts. Each stream raw streaming data 138 may be processed by streaming data processor 137 and stored within data store 130 (e.g., on storage media 131). As used herein, “streaming data” may encompass data that is sometimes described as real time, near-real time, or seemingly near real time data. In general, such data may be used to create features that are based on short term (i.e., more recent) data.

Data received by data store 130 may also be in the form of one or more instances of raw batch data 136, which may be historical data that is not necessarily classified as “streaming” data. In some examples, raw batch data 136 may represent large blocks of data to be processed by systems or elements of FIG. 1 at a single time, typically in batches or groups (as opposed to relatively continuously, as in streaming data). Upon ingestion, raw batch data 136 may be processed by batch data processor 135 and stored within data store 130 (e.g., on storage media 131). As used herein, “batch data” may encompass historical data or data that may be used to create features that are based on medium or long term data (i.e., less recent data). In some cases, raw batch data 136 may form the basis for data that is used to train one or more models 120, but raw batch data 136 may also be used for online operations (e.g., model scoring) operations in addition to offline operations (e.g., training).

In general, data stored within data store 130 may include both raw data and feature data (calculated from the raw data) that falls along a continuum of time, where that continuum ranges from the most recent or real time data (short term data) to less recent data (long term data). Each of models 120 may operate on data falling on many points along this time continuum, and input data for model 120 may use features that depend on various time frames. For example, for a given model 120 to determine whether a credit card transaction may be fraudulent, that model 120 may more accurately make such a determination if the model has access to data about both the most recent transactions associated with that credit card (which may have occurred only moments ago) and less recent transactions (which may have taken place weeks or months ago). Accordingly, as illustrated in FIG. 1, raw streaming data 138 may be received by data store 130 through a different process than raw batch data 136, since the source of the raw streaming data 138 may involve online or production systems that create the data. Raw batch data 136, on the other hand, may be sourced from any of a variety of systems, including sources of training data or various test sets that may be used to train or verify one or more of model 120.

Raw batch data 136 may also eventually be sourced from data store 130 itself, as the rolling windows of data that follow the passage of time effectively converts raw streaming data 138 into historical data. In other words, data that was once real time or short-term data eventually becomes, with the passage of time, medium term or long term (historical) data, and in some cases, may be considered raw batch data 136.

In operation, and in accordance with one or more aspects of the present disclosure, system 100 of FIG. 1 may receive both raw batch data 136 and raw streaming data 138. For instance, in an example that can be described in the context of FIG. 1, batch data processor 135 detects input that it determines corresponds to raw batch data 136. In some examples, batch data processor 135 may perform a first level of feature calculations using raw batch data 136 to facilitate later calculations that may be performed by interface 110 when responding to requests from computing system 101.

Similarly, streaming data processor 137 detects one or more streams of raw streaming data 138. Streaming data processor 137 processes each stream of raw streaming data 138. In some examples, streaming data processor 137 may perform a first level of feature calculations using one or more of the streams of raw streaming data 138. Since the data raw data 138 is streaming data, batch data processor 135 may continue to receive additional sequences of raw streaming data 138, as such data is captured (e.g., by other systems, not specifically shown in FIG. 1) and fed to system 100.

Data store 130 may store information about raw batch data 136 and raw streaming data 138. For instance, after processing raw batch data 136, batch data processor 135 outputs the processed data generated by batch data processor 135 (and in some examples, some or all of raw batch data 136) to data store 130. Data store 130 stores the data sent by batch data processor 135 on storage media 131. Similarly, after processing raw streaming data 138, streaming data processor 137 outputs the processed data generated by streaming data processor 137 (and in some examples, some or all raw streaming data 138) to data store 130. Data store 130 stores the data sent by streaming data processor 137 on storage media 131.

Interface 110 may receive a request to apply one of models 120. For instance, again continuing with the example being described in the context of FIG. 1, computing system 101 detects signal 193 (e.g., over network 195) from device 190. Computing system 101 determines that the signal corresponds to a request to perform an action (e.g., approve a loan application), where that action requires a prediction to be made (or score to be generated) by a given model 120. Computing system 101 outputs information about signal 193 (e.g., request 102) over network 105 to interface 110. Feature filter 114, included within interface 110, uses the information about the signal to identify the appropriate model 120 to be used to make the appropriate prediction. Feature filter 114 also determines which features will be needed as input to the identified model 120.

Interface 110 may collect feature data. For instance, continuing with the example, feature filter 114 outputs information about the needed features to batch feature filter 116 and streaming feature filter 118. Batch feature filter 116 interacts with data store 130 to retrieve the desired batch data 146 from data store 130 or storage media 131 within data store 130. In some examples, batch data 146 may include raw batch data as well as certain features calculated by batch data processor 135 based on raw batch data 136. Similarly, streaming feature filter 118 interacts with data store 130 to retrieve streaming data 148 from data store 130 (or storage media 131). In some examples, streaming data 148 may include raw streaming data as well as at least some of the features calculated by streaming data processor 137 based on raw streaming data 138.

Feature filter 114 receives batch data 146 from batch feature filter 116 and streaming data 148 from streaming feature filter 118. Feature filter 114 may perform further processing on batch data 146 and/or streaming data 148 to derive any new features that may be needed by the appropriate model 120. In some examples, batch feature filter 116 and streaming feature filter 118 may have previously performed certain calculations in preparation for or in anticipation of a request for features needed by the identified model 120. Such anticipatory calculations may be relevant to other features and may be performed to ensure that the features needed by interface 110 (and models 120) to respond to a request by computing system 101 are readily (and quickly) available when requested.

Interface 110 may apply a model to the input data. For instance, still continuing with the example, feature filter 114 generates model input data 103 using batch data 146 and streaming data 148. In some examples, feature filter 114 may use aspects of request 102 to generate model input data 103 (e.g., request 102 may identify an IP address of 191, a customer number associated with device 190, information about the context in which the signal from device 190 was received over network 195, or other information). Feature filter 114 outputs model input data 103 to the identified model 120 to cause that model 120 to generate model output data 104. Feature filter 114 receives model output data 104 from the identified model 120 and outputs information about the model output data 104 over network 105 to computing system 101.

Computing system 101 may act on the prediction made by model 120. For instance, still continuing with the example in FIG. 1, computing system 101 receives model output data 104 over network 105. Computing system 101 determines that model output data 104 includes a prediction, recommendation, or model scoring information. Computing system 101 uses the model output data 104 to respond to signal 193. For example, computing system 101 may respond to signal 193 by sending data to device 190 over network 195 (e.g., sending data sufficient to enable device 190 to present loan approval or denial information within a user interface displayed by device 190). Alternatively, or in addition, computing system 101 may act on signal 193 by sending one or more control signals to one or more other computing systems to control the operation of such computing systems and/or to adjust operations performed by such computing systems.

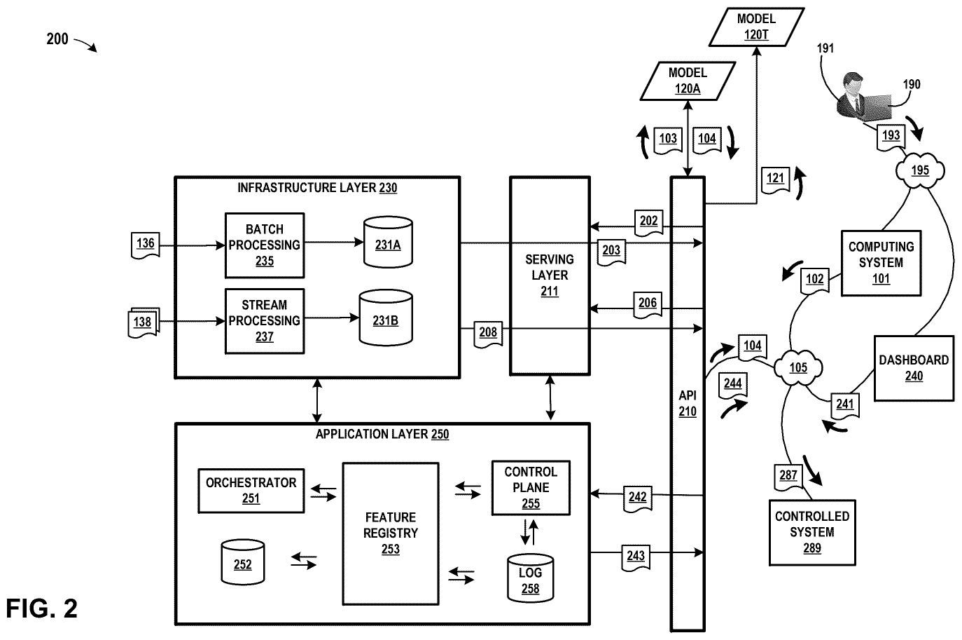

FIG. 2 is an alternative conceptual diagram illustrating an example system for processing features and performing feature engineering tasks in a time-sensitive artificial intelligence environment, in accordance with one or more aspects of the present disclosure. System 200 of FIG. 2 includes infrastructure layer 230, serving layer 211, and application layer 250. API 210 serves as an interface (i.e., an application programming interface) that provides access to services provided by each of infrastructure layer 230, serving layer 211, application layer 250, and any number of models 120 (including, for example, the models 120A and 120T illustrated in FIG. 2). Serving layer 211 may perform feature serving on the fly and provide compute resources using a combination of streaming (real time) and historical data to yield requested features on a near-real time or otherwise timely basis.

System 200 of FIG. 2 has some similarities to system 100 of FIG. 1. Although illustrated on the right-hand side of FIG. 2, computing system 101 and network 105 in FIG. 2 are included in system 200 as is device 190 (operated by user 191) and network 195. These elements of FIG. 2 also appear in FIG. 1, and may correspond to and/or operate in a manner similar to those elements described and having the same reference numeral in connection with FIG. 1.

Also, on the left-hand side of FIG. 2, one or more instances of raw batch data 136 are processed by batch data processor 235 of infrastructure layer 230 of FIG. 2. The data generated by batch data processor 235 may be stored in data store 231A along with, in some cases, some or all of the raw batch data 136 processed by batch data processor 235. Similarly, one or more streams of raw streaming data 138 may be processed in parallel by streaming data processor 237 of infrastructure layer 230 of FIG. 2. The data generated by streaming data processor 237 may be stored in data store 231B along with, in some cases, some or all of the raw streaming data 138 processed by streaming data processor 237. Although illustrated separately in FIG. 2, data stores 231A and 231B may be logically or physically combined into a single data store.

Infrastructure layer 230 of FIG. 2 may correspond to and operate in a manner similar to data store 130 of FIG. 1. Similarly, batch data processor 235 and streaming data processor 237 shown within infrastructure layer 230 of FIG. 2 may correspond to batch data processor 135 and streaming data processor 137 of FIG. 1, respectively. Models 120A and 120T may be examples of models 120 of FIG. 1. Data stores 231A and 231B may correspond to storage media 131 of FIG. 1. And in general, like-numbered elements illustrated in FIG. 2 may represent previously described elements illustrated in FIG. 1 having the same reference numeral.

System 200 of FIG. 2 has, in some respects, a slightly different architecture than system 100 of FIG. 1. For example, API 210 and serving layer 211 of FIG. 2 may collectively operate in a manner similar to interface 110 of FIG. 1.

FIG. 2 also includes elements not present in system 100 of FIG. 1. For example, system 200 of FIG. 2 includes dashboard system 240, which may receive commands from one or more devices 190 (e.g., each of which operated by a user 191) and interact with infrastructure layer 230 through API 210. In addition, system 200 includes controlled system 289, which may, in some examples, be a system controlled by computing system 101 based on model output data 104 received by computing system 101.

In addition, some or all aspects of application layer 250 of FIG. 2 are not shown in FIG. 1. In FIG. 2, application layer 250 provides logging and monitoring infrastructure, and includes integrated access controls for compliance. Application layer 250 also includes capabilities for job orchestration (e.g., by job orchestrator 251) to ingest and process batch feature data with little or no intervention. Control plane 255 of application layer 250 may perform and/or coordinate many aspects of the operation and functions of application layer 250, including monitoring operations performed by infrastructure layer 230, serving layer 211, and API 210, as well as logging data and other information in log 258. Application layer 250 also includes feature registry 253 and metadata store 252, which may be maintained and/or administered by job orchestrator 251. Job orchestrator 251 may perform operations relating to calculating features based on data stored within infrastructure layer 230, and may populate feature registry 253 with entries relating to such features and the calculation of such features. Control plane 255 may also interact with feature registry 253 and/or metadata store 252 when performing various functions.

In operation, and in accordance with one or more aspects of the present disclosure, system 200 of FIG. 2 may ingest both raw batch data 136 and raw streaming data 138. For instance, in an example that can be described in the context of FIG. 2, batch data processor 235 detects input that it determines corresponds to raw batch data 136. Batch data processor 235 processes raw batch data 136 and outputs information about the processed raw batch data 136 to data store 231A, which may be used for storing batch data and/or certain features derived from the batch data in infrastructure layer 230 of FIG. 2. In some examples, and in a manner analogous to that described in connection with FIG. 1, batch data processor 235 may perform a first level of feature calculations on raw batch data 136 to facilitate further calculations that may be performed by other elements of system 200.

Similarly, streaming data processor 237 detects one or more streams of raw streaming data 138, and processes each such stream of raw streaming data as the data arrives as input at infrastructure layer 230. Streaming data processor 237 outputs information about the processed raw streaming data 138 to data store 231B, which may be used for storing streaming data and/or certain features derived from the streaming data in infrastructure layer 230. Again, in some examples, streaming data processor 237 may perform a first level of feature calculations using one or more of the streams of raw streaming data 138 when passing each such stream of data 138 to data store 231B.

System 200 may collect information about data and/or features processed by infrastructure layer 230. For instance, continuing with the example being described, infrastructure layer 230 collects attributes, metadata, and/or other information about features that batch data processor 235 may have derived from the raw batch data 136 received by batch data processor 235. Infrastructure layer 230 outputs this information to application layer 250. Application layer 250 (e.g., control plane 255) uses the information to create an entry in feature registry 253 pertaining to the batch features.

Similarly, infrastructure layer 230 collects attributes, metadata, and/or other information about features that streaming data processor 237 may have derived from the raw streaming data 138 received by streaming data processor 237. Infrastructure layer 230 outputs this information to application layer 250, and control plane 255 of application layer 250 uses the information to create an entry in feature registry 253 pertaining to streaming features.

Application layer 250 may also update metadata store 252 to include information about entries within feature registry 253 and/or about features available through API 210 or otherwise available through system 200. In some examples, rather than making separate entries for both batch and streaming feature information, infrastructure layer 230 may output a combined set of information to application layer 250, and application layer 250 may use the combined information to create one or more entries within feature registry 253.

Feature registry 253 may serve as an organized log of information about features available to serving layer 211 and other elements of system 200, and may also provide information about the processing performed by system 200 to calculate features used by serving layer 211. In some examples, feature registry 253 may be used to coordinate calculation of features, taking into account versioning issues for features that may be calculated based on rolling timeframes that change as time passes. Feature registry 253 may also serve to identify possible data issues, analytical issues, or failures relating to data collection or calculating or generating one or more features being used by serving layer 211.

In some examples, job orchestrator 251 may coordinate various aspects of the processing of raw batch data 136 and raw streaming data 138. For instance, again with reference to FIG. 2, job orchestrator 251 may create tasks or jobs when one or more batches of raw batch data 136 are ingested, which may involve preprocessing such data, normalizing such data, converting such data, performing calculations on various data derived from raw batch data 136, and/or storing such data in data store 231A. Job orchestrator 251 may break up such operations into multiple jobs, enabling multiple processors to be deployed to efficiently manage and complete such tasks. Job orchestrator 251 may also create jobs for continuously or periodically creating and/or updating entries within feature registry 253 across rolling data timeframes, and may store or update in metadata store 252 to provide additional information about various features represented by entries in feature registry 253.

Job orchestrator 251 may also use existing entries in feature registry 253 (or information in metadata store 252) when determining the most efficient way to process raw batch data 136. For example, job orchestrator 251 may use information in feature registry 253 to avoid duplicative processing where calculations performed on raw batch data 136 may be reused when creating multiple features. Similarly, streaming data processor 237 may process multiple continuous or nearly continuous streams of raw streaming data 138, and job orchestrator 251 may create various jobs for each of those streams, enabling efficient processing of the streams of data 138. Job orchestrator 251 may also add or update entries in feature registry 253, and use information stored within feature registry 253 to ensure efficient job creation and processing pertaining to raw streaming data 138. Further, in some examples, job orchestrator 251 may schedule jobs to calculate an array of features that are expected to be requested and/or used within system 200, where such features are based on data stored in data store 231A and 231B. Job orchestrator 251 may schedule such features to be calculated even prior to receiving a request for such features, thereby helping to ensure that such features are available and ready to be used in timely manner to meet low-latency requirements that may pertain to some applications.

API 210 may receive a request to apply one of models 120 to generate a prediction. For instance, again with reference to the example being described in the context of FIG. 2, computing system 101 detects signal 193 (e.g., over network 195) from device 190 (e.g., operated by user 191). Computing system 101 determines that the signal corresponds to an interaction that requires computing system 101 to perform an action (e.g., approve a loan), where that action involves using one or more of models 120 to generate a prediction (e.g., predict credit worthiness of user 191). Responsive to signal 193, computing system 101 outputs request 102 over network 105 to API 210. API 210 evaluates request 102 and determines that it represents a request to apply one of model 120. API 210 uses request 102 to identify an appropriate model for assessing the creditworthiness of user 191 (e.g., model 120A). API 210 also identifies features (i.e., “required features”) that are needed by model 120A to generate a prediction.

API 210 may request the features needed for enabling model 120A to generate a prediction. For instance, still continuing with the example and with reference to FIG. 2, API 210 outputs feature query 202 to serving layer 211, specifying the required features. In some cases, feature query 202 identifies which required features are needed from infrastructure layer 230. In addition, however, feature query 202 may identify other information, such as the context in which request 102 was made. For example, request 102 may identify a specific customer number associated with request 102 (e.g., a customer number associated with user 191) or specific attributes associated with a requesting device (e.g., the IP address of device 190). In some cases, a given model 120 may only need feature data pertaining to a specific user 191 or a specific device 190. Other appropriate contexts for request 102 may also be specified in feature query 202. Responsive to feature query 202, serving layer 211 interacts with infrastructure layer 230 to collect the data stored in data stores 231A and 231B that is needed to calculate or otherwise generate the required features in the specified context. In some cases, serving layer 211 may determine (e.g., based on interactions with feature registry 253) that some or all of the required features have already been partially or fully calculated by job orchestrator 251. In that case, some features may already be stored in data stores 231A and 231B, and serving layer 211 may simply retrieve the calculated features that are already available in data stores 231A and 231B.

Serving layer 211 may calculate any remaining features. For instance, again with reference to FIG. 2, serving layer 211 interacts with infrastructure layer 230 to cause infrastructure layer 230 to retrieve the required batch data from data store 231A and the required streaming data from data store 231B. In some cases, serving layer 211 may initiate more than one request to infrastructure layer 230 (e.g., serving layer 211 may issue separate requests to infrastructure layer 230, one request for batch data from data store 231A, and another request for streaming data from data store 231B). Based on the retrieved data, serving layer 211 calculates the required features and causes them to be stored in data stores 231A and 231B. In some examples, to calculate the required features, serving layer 211 may enable job orchestrator 251 to create jobs to perform calculations and store the resulting calculated features in data stores 231A and 231B. Infrastructure layer 230 responds to feature query 202 by outputting, to serving layer 211 and ultimately to API 210, feature query response 203. Feature query response 203 includes the required features responsive to feature query 202.

API 210 may apply model 120A. For instance, continuing with the example being described, API 210 uses feature query response 203 to generate model input data 103. Model input data 103 may include the required features calculated in response to feature query 202. In some cases, request 102 may include other information that may be used by model 120A to make a prediction. API 210 applies model 120A to model input data 103, thereby generating model output data 104.

Serving layer 211 may update feature registry 253. For instance, again with reference to FIG. 2, serving layer 211 outputs information to application layer 250 describing the features collected, calculated, and/or used to cause model 120A to generate a prediction. Control plane 255 of application layer 250 updates feature registry 253 to update any entries within feature registry 253 to reflect any additional feature calculations performed and any updates made to data stores 231A and 231B, and to reflect the application of model 120A to model input data 103. Such entries may provide visibility into the updated feature data stored and available within data stores 231A and 231B and how such data may have been used by API 210 and/or serving layer 211.

API 210 may respond to request 102. For instance, continuing with the example being described in the context of FIG. 2, API 210 outputs model output data 104 over network 105 to computing system 101, thereby responding to request 102. In some examples, model output data 104 may include a prediction or a score pertaining to request 102. For example, where request 102 corresponds to a request to predict the creditworthiness of user 191, model output data 104 may include a prediction of that user's creditworthiness, where the prediction may be expressed in terms of a score (e.g., 0 to 100), a category (“low credit risk” to “medium credit risk” to “high credit risk”), a binary response (“approved” or “denied”), or in other terms.

Computing system 101 may act on model output data 104. For instance, again continuing with the example, computing system 101 uses model output data 104 to respond to signal 193. For example, computing system 101 may output information, based on model output data 104, to device 190 over network 195. Such information may include data enabling to present information within a user interface displayed by device 190 (e.g. presenting the result of prediction made by model 120A).

Alternatively, or in addition, computing system 101 may act on model output data 104 by controlling other systems. For instance, again continuing with the example being described, computing system 101 evaluates model output data 104. Based on the evaluation, computing system 101 outputs one or more control signals 287 to controlled system 289 to thereby cause controlled system 289 to perform specific operations and/or to change its operation in response to control signals 287. Where signal 193 corresponds to a request for a loan application, for example, controlled system 289 may be a computing system operated by a bank that is capable of opening loan accounts. In such an example, computing system 101 may output control signals 287 to controlled system 289 once the loan application for user 191 is approved, where the control signals 287 instruct controlled system 289 to open a loan account for a specified credit line, and perform any other appropriate administrative tasks associated with such an operation.

In a different example, where signal 193 corresponds to a request to approve a credit card transaction, controlled system 289 may be a computing system operated by a credit card processor that is capable of processing a credit card transaction. In such an example, computing system 101 may output control signals 287 to controlled system 289 if the transaction is approved (e.g. by one of models 120) to thereby cause controlled system 289 to process the specified credit card transaction and perform appropriate accounting tasks associated with the transaction. Alternatively, computing system 101 may output control signals 287 to controlled system 289 if the transaction is denied (e.g., by one of models 120) to thereby cause controlled system 289 to designate the specified credit card transaction as being denied, and possibly, to take other steps to prevent any fraud that may be indicated by the proposed transaction.

In yet another example, where signal 193 corresponds to a request to access secure resources gated by computing system 101, controlled system 289 may be a security device capable of taking actions in response to on potential attempts to hack into computing system 101. In this example, computing system 101 may output control signals 287 to controlled system 289 if an access request is denied. The control signal 287 cause the controlled system 289 to evaluate the access request as a possible hacking attempt and take mitigating actions (e.g., deny other requests, adjust a firewall, or route network traffic differently) to protect resources that may be threatened by such a hacking attempt.

Control plane 255 may observe and/or monitor some or all of the operations that have been described herein as being performed within system 200. For instance, in some examples that can be described in connection with FIG. 2, control plane 255 has visibility into operations and data flows within system 200. Accordingly, control plane 255 is capable of monitoring all requests and responses processed by API 210 and/or serving layer 211, and as a result, control plane 255 is capable of monitoring when various features are invoked or used, when entries are made in feature registry 253, and other operations performed within system 200.

This operational visibility and/or monitoring capability by control plane 255 may be used for logging information about operations performed by system 200. For example, still with reference to FIG. 2, control plane 255 monitors system 200 and outputs to log 258 a sequence of information about some or all of operations performed by any of elements, systems, components, and/or modules of system 200. Log 258 may store such information for immediate or later analysis. In some cases, other elements having visibility into operations within system 200 may also output information to log 258 for storage and/or analysis. For example, feature registry 253 may update log 258 with information about features being calculated, added, or available.

Information stored within log 258 may enable elements both within system 200 and outside of system 200 to perform analyses of operations performed within system 200. For instance, again with reference to FIG. 2, systems internal or external to system 200 may perform analyses using the logged information, and such analysis may involve determining whether any errors and/or failures have occurred within system 200. Such analysis may also enable an assessment of the performance of 200 and/or any of the elements of system 200 (e.g., timing analysis, service level agreement compliance, resource utilization analysis). Such analysis may further include diagnosing, debugging, and/or evaluating any anomalies, errors, or other issues arising within the context of system 200. Such analysis may involve evaluating the operation, performance, or efficiency of queries made for inference features (e.g., applying one or more models 120 to enable computing system 101 to perform a function), or of queries for historical features (e.g., enabling computing system 101 or another system to train or retrain one of models 120). Still further, such analysis may also enable analysis of operations performed at the direction of job orchestrator 251 or control plane 255. Accordingly, the information stored in log 258 may be comprehensive, and such information may include, without limitation, information about requests to and responses from API 210, interactions serving layer 211 has with infrastructure layer 230 and features generated by serving layer 211, data stored by infrastructure layer 230, entries made in feature registry 253 and other data stored in metadata store 252, operations performed at the direction of job orchestrator 251, and interactions between any of the elements of system 200.

This operational visibility and/or monitoring capability by control plane 255 may also be used in connection with providing access control functions. Some industries, such as finance, tend to be highly regulated, and at least some of that regulation pertains to controlling access to various information (e.g., privacy-implicated information about users, banking information, and other information). Therefore, control plane 255 may operate to provide users with different levels of access to features of system 200, sometimes motivated due to regulatory concerns, but often also motivated by business and/or security concerns. Similarly, access provided to various elements of 200, such as models 120, may also be limited in some contexts so that such elements have access to only certain types of data or features of system 200. Control plane 255 thus may gate access to data and operations of system 200, thereby regulating the access capabilities for both users and elements of system 200. Control plane 255 may limit and/or manage access to certain data and capabilities of system 200 based on user identity, based on roles held by various users, or based on specific models 120.

In some examples, the described access control functionality, as administered by control plane 255, may ensure that requests 102 received by API 210 are not outside the bounds of the privileges of the user 191 associated with a given request 102. For instance, feature registry 253 may play a role in administering access by providing information about the data underlying certain features, so that if a given user 191 or model 120 does not have access to the underlying data for certain features, control plane 255 may limit access to those features as well. Accordingly, control plane 255 may administer access to both the derived features (e.g., as maintained by feature registry 253) and the underlying data for those features.

In at least some of the examples described herein in connection with FIG. 2, computing system 101 uses API 210 to apply one or more of models 120 to data in order to generate a score or prediction. In these examples, a system, such as computing system 101, typically issues a request 102 to API 210, and API 210 responds with model output data 104 which enables computing system 101 to perform an operation (e.g., approve or deny a bank loan or account application).

However, the architecture of system 200 may also be used concurrently for other purposes, such as training (or retraining) one or more models 120. For instance, in another example that may be described with reference to FIG. 2, computing system 101 outputs request 102 over network 105 to API 210. API 210 evaluates request 102 and determines that it corresponds to a request to train one of models 120, such as model 120T. API 210 may further determine that request 102 specifies attributes of the training data to be used when training model 120T. API 210 outputs training data query 206 to serving layer 211, representing a query for historical features. Infrastructure layer 230 evaluates training data query 206 and identifies the features requested. Infrastructure layer 230 outputs training data response 208 from data store 231A to serving layer 211. Serving layer 211 uses the data from data store 231B to generate training data 121. Serving layer 211 uses training data 121 to interact with model 120T, and thereby train (or retrain) model 120T.

System 200 may also be used to provide administrative, developer, or other access to feature registry 253. For instance, in an example where user 191 is a data scientist in the process of developing a model that may use some of the features available through API 210, application layer 250 may enable the data scientist to access and/or browse information within feature registry 253. Such a capability may enable the data scientist to identify features that are already available within infrastructure layer 230 based on raw batch data 136 and/or raw streaming data 138, and that may be reused for the newly developed model.

In such an example, device 190 may send a signal to dashboard system 240 in response to input detected by device 190 (e.g., where device 190 is operated by user 191, who may be a data scientist in this example). Dashboard system 240 evaluates the signal and determines that the signal corresponds to a request, by device 190, to generate a user interface. In some examples, the requested user interface may present information about potentially reusable features that may already be available based on calculations already performed by system 200 using raw batch data 136 and/or raw streaming data 138. Dashboard system 240 outputs dashboard query 241 over network 105 to API 210. API 210 issues dashboard API call 242 to feature registry 253 (within application layer 250) to identify features available for use in a new model. Feature registry 253 outputs dashboard API response 243 to API 210. API 210 uses dashboard API response 243 to respond to dashboard query 241 with dashboard response data 244. Dashboard system 240 receives dashboard response data 244 over network 105. Dashboard system 240 uses dashboard response data 244 to generate user interface data. Dashboard system 240 outputs the user interface data over 195, which enables presentation of a user interface at device 190. In such an example, the presented user interface may allow data scientist/user 191 to access and/or browse information within feature registry 253 to evaluate features calculated or maintained by infrastructure layer 230.

System 200 may also be used to enable access to administrative functions. For instance, in an example where user 191 is an administrator or compliance monitor, application layer 250 may enable user 191 to generate and present reports providing information that may be used for administrative purposes, which may pertain to security, access control, compliance, or other purposes. In such an example, and similar to other examples described above, device 190 responds to input from user 191 by outputting signal 193 over network 195. In this example, dashboard system 240 determines that signal 193 corresponds to a request to retrieve administrative information. Dashboard system 240 outputs dashboard query 241 over network 105. API 210 receives dashboard query 241 and issues dashboard API call 242, causing application layer 250 to respond with dashboard API response 243. API 210 uses dashboard API response 243 to generate and output dashboard response data 244 to dashboard system 240. Dashboard system 240 uses dashboard response data 244 to generate a user interface for presentation at device 190, where the user interface includes the administrative information requested by user 191.

System 200 may also enable compliance-related capabilities. For instance, in some examples, when one or more of models 120 generate a score (e.g., model output data 104) that is used by computing system 101 to perform an action (e.g., approve or deny a loan, transaction, or account opening), control plane 255 saves (e.g., within log 258) information in parallel about the model output data 104 along with all the features and/or underlying raw data used by the model 120 to generate model output data 104. One possible use for such data is to be able to respond to queries from compliance monitors that may arise if there is any question about why a particular score was generated and then acted upon in a certain way. For example, if a loan, transaction, or account was denied (or approved), log 258 may have information about the factors underlying any predictions made by the relevant models 120, thereby enabling reproduction and assessment of how such models 120 operate, and whether such models 120 operate appropriately and without bias. Such a capability may be particularly helpful in the context of compliance, such as in the financial industry, where industry members tend to be heavily regulated and may need to be able to justify actions taken by corporate actors. Such justifications can be complicated when corporate actions are driven by machine learning models and other artificial intelligence systems.

Techniques described herein may provide certain technical advantages. For instance, by infrastructure layer 230 storing features in a low latency data store (e.g., data stores 231A and 231B), API 210 is capable of responding to feature queries in a timely manner. Further, by performing multiple levels of feature calculation (e.g., calculating features upon ingestion of raw batch data 136 and raw streaming data 138 by infrastructure layer 230, calculating features in anticipation of future requests, and enabling serving layer 211 to perform calculations in response to API queries), API 210 may be able to respond to feature queries in a near-real time manner, and more quickly than possible in other architectures. Such responsiveness may enable use of more complex features in high-demand contexts and for applications that require complex algorithms to compute model features, where such features are needed in near- or seemingly near-real time. By maintaining information about calculated features in feature registry 253, duplicative processing may be avoided and feature computation can be performed in a highly efficient manner, also improving responsiveness.

In addition, by logging data about operations performed by system 200 and maintaining information about features calculated, features used, and features applied by various models 120 during operation, useful information is available within system 200. For example, such information may include information sufficient to respond to various compliance requests, thereby making system 200 particularly applicable and useful in certain contexts, such as highly regulated industries (e.g., finance). Such information may also enable access control capabilities, limiting access to features and underlying data only to authorized users or models, and enabling use of such information for verification of access constraints.

Further, by maintaining raw batch data 136 and raw streaming data 138 in parallel, using the same infrastructure, multiple types of services can be made available through an accessible interface (e.g., API 210). Such services may include online operations (e.g., model scoring), offline operations (e.g., model training), and administrative services (e.g., reporting and compliance).

In addition, by making various feature engineering services available through an accessible user interface, a diverse array of computing systems and users may benefit from feature engineering services capabilities. For example, users and systems may access and use features calculated by serving layer 211 and maintained by infrastructure layer 230, with little or no duplication of efforts or duplication of calculations needed for features used by any of multiple models 120 that serve diverse computing systems 101.

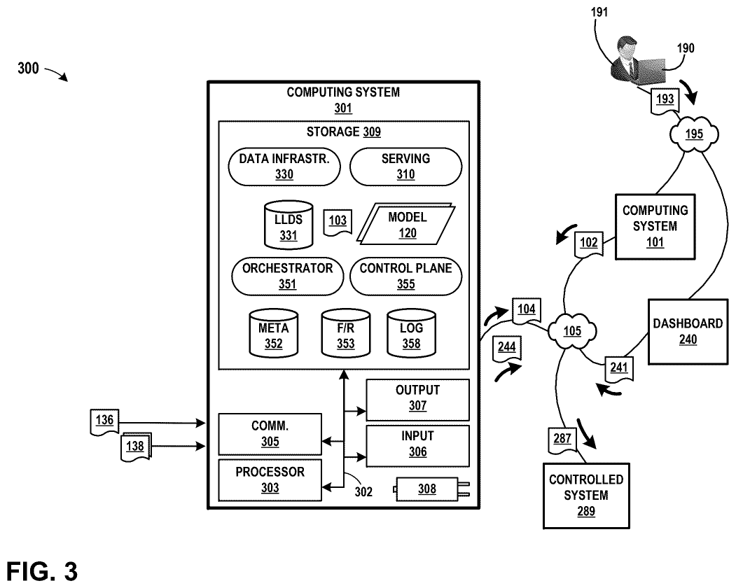

FIG. 3 is a block diagram illustrating an example system for processing features and performing administrative tasks in a time-sensitive artificial intelligence environment, in accordance with one or more aspects of the present disclosure. System 300 of FIG. 3 includes computing system 301, which illustrates an example of how certain elements of FIG. 2 might be implemented as part of a computing system. Computing system 301 is illustrated in FIG. 3 to facilitate a description of how a computing system and certain components, modules, and other aspects of a computing system implementing a data store for feature engineering may operate. Accordingly, computing system 301 of FIG. 3 may be considered an example or alternative implementation of certain elements of FIG. 2.

For ease of illustration, computing system 301 is depicted in FIG. 3 as a single computing system. However, in other examples, computing system 301 may be implemented through multiple devices or computing systems distributed across a data center, multiple data centers, or multiple cloud networks. For example, separate computing systems may implement functionality described herein as being performed by each of serving module 310, data infrastructure module 330, orchestration module 351, and control plane module 355. Alternatively, or in addition, modules illustrated in FIG. 3 as included within computing system 301 may be implemented through distributed virtualized compute instances (e.g., virtual machines, containers) of a data center, cloud computing system, server farm, and/or server cluster. In some examples, computing system 301 may operate within a single cloud network, but in other examples, computing system 301 may operate across multiple cloud networks. Although computing system 301 of FIG. 3 may be considered an example implementation of a computing system corresponding to aspects of system 200 of FIG. 2, other implementations are possible.

In FIG. 3, certain elements external to computing system 301 are illustrated in a manner similar to FIG. 2 (e.g., computing system 101, dashboard system 240, controlled system 289). Such elements illustrated in FIG. 3 may correspond to earlier-described elements sharing the same reference numeral.

In FIG. 3, computing system 301 is shown with underlying physical hardware that includes power source 308, one or more processors 303, one or more communication units 305, one or more input devices 306, one or more output devices 307, and one or more storage devices 309. Power source 308 of computing system 301 may provide power to one or more components of computing system 301. One or more processors 303 of computing system 301 may implement functionality and/or execute instructions associated with computing system 301 or one or more modules illustrated and/or described herein. One or more processors 303 may be, may be part of, and/or may include processing circuitry that performs operations in accordance with one or more aspects of the present disclosure. One or more communication units 305 of computing system 301 may communicate with devices external to computing system 301 by transmitting and/or receiving data, and may operate, in some respects, as both an input device and an output device. In some or all cases, one or more communication units 305 may communicate with other devices or computing systems over network 105 or over other networks.

One or more input devices 306 may represent any input devices of computing system 301 not otherwise separately described herein, and one or more output devices 307 may represent any output devices of computing system 301 not otherwise separately described herein. Input devices 306 and/or output devices 307 may generate, receive, and/or process output from any type of device capable of outputting information to a human or machine. For example, one or more input devices 306 may generate, receive, and/or process input in the form of electrical, physical, audio, image, and/or visual input (e.g., peripheral device, keyboard, microphone, camera). Correspondingly, one or more output devices 307 may generate, receive, and/or process output in the form of electrical and/or physical output (e.g., peripheral device, actuator).

One or more of the devices, modules, storage areas, or other components of computing system 301 may be interconnected to enable inter-component communications (physically, communicatively, and/or operatively). In some examples, such connectivity may be provided by through communication channels, which may include a system bus (e.g., communication channel 302), a network connection, an inter-process communication data structure, or any other method for communicating data.

One or more storage devices 309 within computing system 301 may store information for processing during operation of computing system 301. Storage devices 309 may store program instructions and/or data associated with one or more of the modules described in accordance with one or more aspects of this disclosure. One or more processors 303 and one or more storage devices 309 may provide an operating environment or platform for such modules, which may be implemented as software, but may in some examples include any combination of hardware, firmware, and software. One or more processors 303 may execute instructions and one or more storage devices 309 may store instructions and/or data of one or more modules. The combination of processors 303 and storage devices 309 may retrieve, store, and/or execute the instructions and/or data of one or more applications, modules, or software. Processors 303 and/or storage devices 309 may also be operably coupled to one or more other software and/or hardware components, including, but not limited to, one or more of the components of computing system 301 and/or one or more devices or systems illustrated or described as being connected to computing system 301.

Storage devices 309 may include serving module 310, data infrastructure module 330, orchestration module 351, and control plane module 355. Serving module 310 may perform functions similar to those described as being performed by both API 210 and serving layer 211 of FIG. 2. Data infrastructure module 330 may perform functions similar to those described as being performed by infrastructure layer 230 of FIG. 2, and may store feature data and/or raw data in low latency data store 331 (“LLDS”). This data store 331 may generally correspond to data stores 231A and 232B of FIG. 2. Orchestration module 351 may perform functions similar to those performed by job orchestrator 251 included within application layer 250 of FIG. 2, and control plane module 355 may perform functions similar to those performed by control plane 255 included within application layer 250 of FIG. 2. Metadata store 352, feature registry 353, and log 358 may correspond to metadata store 252, feature registry 253, and log 258 of FIG. 2, respectively. Each of these data stores may represent any suitable data structure or storage medium for storing information. The information stored in any of these data stores may be searchable and/or categorized such that one or more modules within computing system 301 may provide an input requesting information, and in response to the input, receive information stored within the appropriate data store. Metadata store 352 and feature registry 353 may be maintained by orchestration module 351. Log 358 may be maintained by control plane module 355.

Modules illustrated in FIG. 3 (e.g., serving module 310, data infrastructure module 330, orchestration module 351, and control plane module 355) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

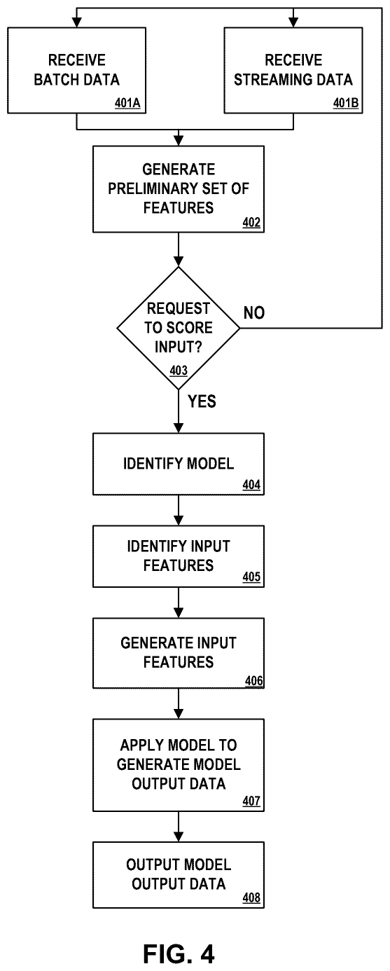

FIG. 4 is a flow diagram illustrating operations performed by an example computing system, in accordance with one or more aspects of the present disclosure. FIG. 4 is described below within the context of computing system 301 of FIG. 3. In other examples, operations described in FIG. 4 may be performed by one or more other components, modules, systems, or devices. Further, in other examples, operations described in connection with FIG. 4 may be merged, performed in a difference sequence, omitted, or may encompass additional operations not specifically illustrated or described.

In the process illustrated in FIG. 4, and in accordance with one or more aspects of the present disclosure, computing system 301 may receive batch and streaming data. For example, in FIG. 3, communication unit 305 of computing system 301 detects input that it determines corresponds to raw batch data 136 (401A). Communication unit 305 outputs information about the raw batch data 136 to data infrastructure module 330. In parallel, communication unit 305 detects input that that it determines corresponds to one or more streams of raw streaming data 138 (401B). Communication unit 305 outputs information about the raw streaming data 138 to data infrastructure module 330. Data infrastructure module 330 ingests raw batch data 136 and raw streaming data 138 and stores the data in data store 331. In some examples, control plane module 355 may monitor the receipt of raw batch data 136 and raw streaming data 138 by data infrastructure module 330, and update feature registry 353 with appropriate entries about the received data.

Computing system 301 may generate a preliminary set of features (402). For example, data infrastructure module 330 of computing system 301 may perform an initial level of feature calculations when both raw batch data 136 and raw streaming data 138 are ingested and/or stored. Such calculations may be performed to facilitate later calculations performed by serving module 310 when generating additional features to present to model 120 when responding to a future request to apply model 120 and/or score future input data. To perform these initial calculations, orchestration module 351 may schedule jobs that perform some or all aspects of the calculations. When scheduling such jobs, orchestration module 351 may consult data stored within feature registry 353 to ensure that the jobs are performed efficiently (e.g., without duplicating other calculations). Control plane module 355 may update feature registry 353 and/or metadata store 352 with information about the calculations.

Computing system 301 may receive a request to score input (403). For example, communication unit 305 detects input that it determines corresponds to request 102 from device 190. Communication unit 305 outputs information about request 102 to serving module 310. Serving module 310 determines that request 102 corresponds to a request to score input data (e.g., apply one of models 120 to specified input data). Based on a determination that request 102 does not correspond to a request to score input data (NO branch of 403), computing system 301 continues to receive and process batch data (401A) and/or streaming data (401B).

Based on a determination that request 102 corresponds to a request to score input data (YES branch of 403), computing system 301 identifies a model (404). For example, serving module 310 evaluates request 102 and determines which of models 120 is to be used to score the input data. Computing system 301 may identify input features for the identified model (405). For example, serving module 310 also uses request 102 (and the identified model 120) to determine what input features are required and/or needed to apply the identified model 120 to the input data.

Computing system 301 may generate input features (406). For example, serving module 310 outputs information about the required features to orchestration module 351. Orchestration module 351 creates and initiates execution of a number of jobs that perform calculations to generate the input features. Orchestration module 351 may access data stored within feature registry 353 and/or metadata store 352 to determine an appropriate or efficient way to perform the calculations. Control plane module 355 monitors the jobs and corresponding calculations and updates feature registry 353 with information about the calculations being orchestrated by orchestration module 351. Control plane module 355 may also store information about the calculated features in metadata store 352. Still further, control plane module 355 may store information about the jobs performed by orchestration module 351 (as well as other operations performed by computing system 301) within log 358.

Computing system 301 may apply the model to the input features to generate model output data (407). For example, based on the calculations orchestrated by orchestration module 351, serving module 310 generates model input data 103. Serving module 310 applies model 120 to model input data 103. In response, model 120 generates model output data 104. Control plane module 355 updates log 358 with information about the application of model 120 to model input data 103 when processing request 102.

Computing system 301 may output model output data (408). For example, serving module 310 causes communication unit 305 to output a signal over network 105. Computing system 101 detects a signal and determines that the signal corresponds to model output data 104 and is responsive to request 102.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The disclosures of all publications, patents, and patent applications referred to herein are hereby incorporated by reference. To the extent that any material that is incorporated by reference conflicts with the present disclosure, the present disclosure shall control.

For ease of illustration, only a limited number of devices (e.g., computing system 101, device 190, controlled system 289, computing system 301, as well as other modules or elements not specifically described as computing systems) are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each illustrate at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the Figures and/or may include additional devices and/or components not shown in the Figures.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner. References herein to “real time” or equivalent phrases are intended to encompass near-real time or seemingly near-real time, such as from the perspective of a reasonable human observer.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, or optical disk storage, magnetic disk storage, or other magnetic storage devices, flash memory, or any other medium that can be used to store desired program code in the form of instructions or data structures and that can be accessed by a computer. Also, any connection may properly be termed a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including, to the extent appropriate, a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

What is claimed is:

1. A method comprising:
receiving, by a computing system, batch and streaming data;
generating, by the computing system and based on the batch and streaming data, a preliminary set of calculated features;
receiving, by the computing system, a request to score input data;
identifying, by the computing system and based on information included in the request, a model and input features for the model;
generating, by the computing system and using the preliminary set of calculated features, the input features;
applying the model, by the computing system, to the input features to generate model output data; and
outputting, by the computing system, the model output data.

2. The method of claim 1, wherein generating the preliminary set of calculated features includes:
storing information about the preliminary set of calculated features in a feature registry; and
accessing the stored information about the preliminary set of calculated features in the feature registry.

3. The method of claim 2, wherein accessing the stored information about the preliminary set of calculated features includes:
identifying a calculated feature, from among the preliminary set of calculated features, that is relevant to least one of the input features; and
using the calculated feature to generate at least one of the input features.

4. The method of claim 1, wherein the request to score input data is a request to score a first set of input data, wherein the model is a first model, and wherein the input features are a first set of input features, the method further comprising:
receiving, by the computing system, a request to score a second set of input data;
identifying, by the computing system and based on information included in the request to score a second set of input data, a second model and a second set of input features;
generating, by the computing system and using the preliminary set of calculated features, the second set of input features; and
applying the second model, by the computing system, to the second set of input features.

5. The method of claim 4, wherein generating the second set of input features includes:
accessing information about the first set of input features in a feature store;
identifying a calculated feature, from among the first set of input features, that can be used to generate at least one of the second set of input features; and
using the calculated feature to generate at least one of the second set of input features.

6. The method of claim 1, wherein receiving the batch and streaming data includes:
storing the batch and streaming data in a low latency data store.

7. The method of claim 1, wherein generating the preliminary set of calculated features includes:
storing the preliminary set of calculated features in a low latency data store.

8. The method of claim 1, wherein the streaming data is a first set of streaming data, and wherein receiving the batch and streaming data includes:
receiving a second set of streaming data; and
designating, after a period of time, the first set of streaming data as batch data.

9. The method of claim 1, further comprising:
identifying, by the computing system, access privileges associated with the request to score input data;
limiting access, by the computing system and based on the access privileges, to a subset of the batch and streaming data; and
limiting access, by the computing system and based on the access privileges, to features calculated from the subset of batch and streaming data.

10. The method of claim 1, further comprising:
receiving, by the computing system and through an interface exposed by the computing system, an administrative request; and
outputting, by the computing system and responsive to the administrative request, information sufficient to generate a user interface.

11. The method of claim 10, wherein outputting information sufficient to generate a user interface includes:
outputting information enabling a compliance audit associated with generating the model output data.

12. The method of claim 10, wherein outputting information sufficient to generate a user interface includes:
accessing information included in a feature registry; and
outputting, based on accessing information in the feature registry, information enabling evaluation of features that the computing system calculates for existing models.

13. The method of claim 1, wherein outputting the model output data includes:
outputting control signals to a controlled system to instruct the controlled system to take an action based on the model output data.

14. A computing system comprising processing circuitry and a storage device, wherein the processing circuitry has access to the storage device and is configured to:
receive batch and streaming data;
generate, based on the batch and streaming data, a preliminary set of calculated features;
receive a request to score input data;
identify, based on information included in the request, a model and input features for the model;
generate, using the preliminary set of calculated features, the input features;
apply the model to the input features to generate model output data; and
output the model output data.

15. The computing system of claim 14, wherein to generate the preliminary set of calculated features, the processing circuitry is further configured to:
store information about the preliminary set of calculated features in a feature registry; and
access the stored information about the preliminary set of calculated features in the feature registry.

16. The computing system of claim 15, wherein to access the stored information about the preliminary set of calculated features, the processing circuitry is further configured to:
identify a calculated feature, from among the preliminary set of calculated features, that is relevant to least one of the input features; and
use the calculated feature to generate at least one of the input features.

17. The computing system of claim 14, wherein the request to score input data is a request to score a first set of input data, wherein the model is a first model, and wherein the input features are a first set of input features, and wherein the processing circuitry is further configured to:
receive, a request to score a second set of input data;
identify, based on information included in the request to score a second set of input data, a second model and a second set of input features;
generate, using the preliminary set of calculated features, the second set of input features; and
apply the second model to the second set of input features.

18. The computing system of claim 17, wherein to generate the second set of input features, the processing circuitry is further configured to:
access information about the first set of input features in a feature store;
identify a calculated feature, from among the first set of input features, that can be used to generate at least one of the second set of input features; and
use the calculated feature to generate at least one of the second set of input features.

19. The computing system of claim 14, wherein to receive the batch and streaming data, the processing circuitry is further configured to:
store the batch and streaming data in a low latency data store.

20. Non-transitory computer-readable media comprising instructions that, when executed, cause processing circuitry of a computing system to:
receive batch and streaming data;
generate, based on the batch and streaming data, a preliminary set of calculated features;
receive a request to score input data;
identify, based on information included in the request, a model and input features for the model;
generate, using the preliminary set of calculated features, the input features;
apply the model to the input features to generate model output data; and
output the model output data.
